(19) United States
(12) Patent Application Publication
(10) Pub. No.: US 2017/0167841 A1
(43) Pub. Date: Jun. 15, 2017

(54) Adjustable square ruler

(71) Applicants: Karen Kay Buckley, Carlisle, PA (US); Joseph David Buckley, Carlisle, PA (US)

(72) Inventors: Karen Kay Buckley, Carlisle, PA (US); Joseph David Buckley, Carlisle, PA (US)

(21) Appl. No.: 14/998,030

(22) Filed: May 4, 2015

(51) Int. Cl. G01B 3/08

(52) U.S. Cl. CPC G01B 3/08

(57) ABSTRACT

The present invention provides an adjustable square ruler or measuring device, comprising four right angled pieces, four first straight pieces, four second straight pieces, four third straight pieces, four fourth straight pieces and four fifth straight pieces. All of the right angled pieces, the first, the second, the third, the fourth and the fifth straight pieces being between 0.05 and 0.15 inch in thickness, made of a transparent material and having five interlocking fingers on one open end and corresponding five interlocking finger openings on another open end. Further, when four right angled pieces are coupled together either separately or together with four of any of the first, the second, the third, the fourth and the fifth straight pieces create a transportable, perfectly flat square or rectangular ruler which can be used for marking, trimming or cutting.

### BACKGROUND OF THE INVENTION

1. Field of the Invention

The present invention is directed generally to marking tools and rulers used in the field of quilting, needlework, sewing and fabric art, specifically an adjustable square ruler.

2. Description of the Prior Art

Quilters, fabric artists, appliquers, sewers, and needlework artists design and create three dimensional objects of art. In many completed projects, identical sized blocks made of fabric need to be created, and then sewn together. Historically fabric artists could use a simple or complex ruler or other devise including thicker plastic rectangular or square rulers of differing sizes to physically mark the fabric, and then cut to the desired size. There is a variety of one piece, square, acrylic rulers with many different markings applied thereto. Quilters, artist, hobbyist or designer would then attempt to “square up” the finished project and either cut it using an acrylic square of the desired cut size and cut along the edge with a rotary cutter; or mark the corners, draw lines and cut along the lines. Hand marking can be inaccurate as the person must move the ruler around the sides as he or she marks, and also because the projects are many times three dimensional, flat, square rulers of the desired size may rock when placed on top of the three dimensional piece creating a distortion. Often the three dimensional piece may be so delicate that the creator of the piece does not desire to place a square ruler on top of the project for fear of damaging it. A solution was to have acrylic frames of the desired size or sizes cut by local glass shops specializing in cutting acrylic. The disadvantage of this is that a person may need numerous cut frames made depending on the project or design. There are also existing squares available but there are none which all four sides sit on the same plane, that being flat on the surface. None have a consistent smooth exterior edge to permit the easy use of a rotary cutter for trimming. Also many if not all have coupling devices such as screws, clips, cogs and pins which could cause potential damage the artwork.

Quilters and sewers generally sew on the quarter inch therefore an adjustable devise which could be in adjusted on the inch or half inch for marking and/or cutting, which is easy to put together, take apart, store and transport is a needed tool. Also the tool needed to be stable so that once assembled could be lifted, moved and used as a cutting or drawing edge.

Therefore as for quilters, sewers, needlepoint artists and fabric artists, there is a need for an adjustable square ruler.

### SUMMARY OF THE INVENTION

The present invention consists of a set of 24 pieces constructed of approximately 1/10 inch thick PETG (Polyethylene terephthalate glycol-modified), a clear amorphous thermoplastic; four corners, each corner having three holes one on the diagonal near the interior corner; and four each of a 1 inch piece, a 1½ inch piece, a 2 inch piece, a 4 inch piece, and an 8 inch piece ; all pieces having a uniform width and all pieces having interlocking ends when joined create various sizes of squares and rectangles for marking, trimming and cutting, as well as finding the exact center of the desired square or rectangle.

The corners have three strategically placed holes, one on the diagonal near the inner corner and two ¼ inch at right angles which enable the user to find the exact center of the project.

The tool will allow the user to build the desired size of square or rectangle using the various “straight” pieces and creating a square either on the inch or the half inch. The thermoplastic material and the thickness and width, together with the interlocking

### BRIEF DESCRIPTION OF THE DRAWINGS

FIG. 1A illustrates a plan view of a right angled piece in accordance with an embodiment of the present invention;

FIG. 1B illustrates a side view of the right angled piece of FIG. 1A, in accordance with an embodiment of the present invention;

FIG. 2A illustrates a plan view of a first straight piece in accordance with an embodiment of the present invention;

FIG. 2B illustrates a side view of the first straight piece of FIG. 2A, in accordance with an embodiment of the present invention;

FIG. 3A illustrates a plan view of a second straight piece in accordance with an embodiment of the present invention;

FIG. 3B illustrates a side view of the second straight piece of FIG. 3A, in accordance with an embodiment of the present invention

FIG. 4A illustrates a plan view of a third straight piece in accordance with an embodiment of the present invention;

FIG. 4B illustrates a side view of the third straight piece of FIG. 4A, in accordance with an embodiment of the present invention;

FIG. 5A illustrates a plan view of a fourth straight piece in accordance with an embodiment of the present invention;

FIG. 5B illustrates a side view of the fourth straight piece of FIG. 5A, in accordance with an embodiment of the present invention;

FIG. 6A illustrates a plan view of a fifth straight piece in accordance with an embodiment of the present invention;

FIG. 6B illustrates a side view of the fifth straight piece of FIG. 6A, in accordance with an embodiment of the present invention;

FIG. 7 illustrates an isometric view of an adjustable square ruler in accordance with an embodiment of the present invention;

FIG. 8 illustrates an isometric view of an adjustable square ruler, having four identical straight pieces, in accordance with an embodiment of the present invention;

FIG. 9 illustrates an isometric view of an adjustable square ruler, having four identical straight pieces, in accordance with another embodiment of the present invention;

FIG. 10 illustrates a right angled piece, a fifth straight piece, a fourth straight piece, a third straight piece and a second straight piece coupled together, in accordance with an embodiment of the present invention;

FIG. 11 illustrates a plan view of an adjustable square ruler in accordance with an embodiment of the present invention; and

FIGS. 12A, 12B and 12C illustrate a plurality of visual steps for determining an exact center of the adjustable square ruler or measuring device using a heavy thread, in accordance with an embodiment of the present invention.

### DESCRIPTION OF THE PREFERRED EMBODIMENT

The adjustable square ruler or measuring device includes four right angled pieces 100, four first straight pieces 200, four second straight pieces 300, four third straight pieces 400, four fourth straight pieces 500 and four fifth straight pieces 600. When four right angled pieces 100 are coupled together either separately or together with four of any of the first 200, the second 300, the third 400, the fourth 500 and the fifth 600 straight pieces create a transportable, perfectly flat square or rectangular ruler which can be used for marking, trimming or cutting.

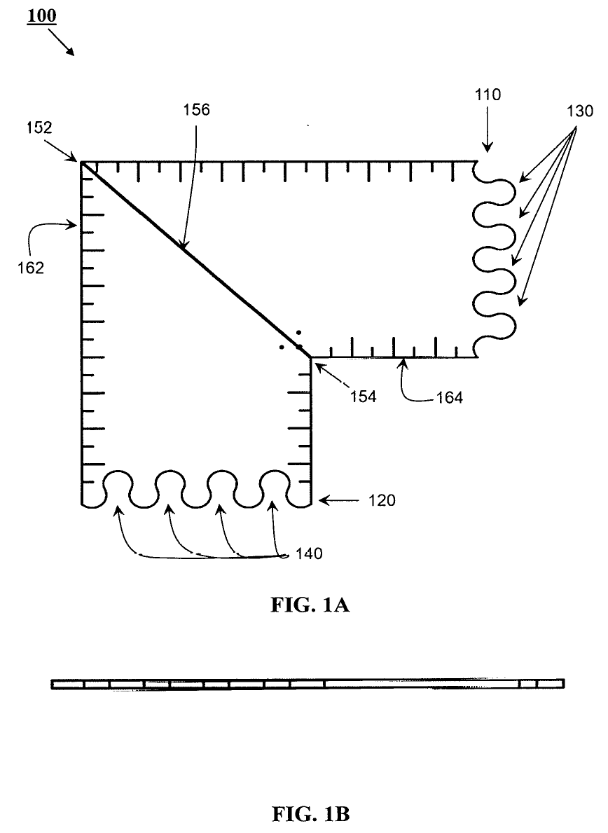

FIG. 1A illustrates a plan view of a right angled piece 100 in accordance with an embodiment of the present invention. The right angled piece 100 is made of a transparent material, each side 2.75 inches in width, with an interior length of 2 inches and an exterior length of 4.75 inches, and having five interlocking fingers 130 on one open end 110 and corresponding five interlocking finger openings 140 on another open end 120. Further, the right angled piece 100 has a diagonal line 156 etched or marked from an outside corner 152 to an inside corner 154. Further, one hole with a diameter between 0.02 and 0.04 inch is drilled on the diagonal line 156 whose middle point is between 0.15 and 0.2 inch from the inside corner 154 of the right angled piece 100. Also, two holes with diameters between 0.02 and 0.04 inch are drilled at right angle points, with respective center points 0.25 inch from a center point of the drilled hole.

Further, the right angled piece 100 has etched or marked along its outside 162 and inside edge 164 every 0.25 inch with the inch marking being largest, the 0.5 inch marking being half the size of the inch marking, the 0.25 inch marking being one half the 0.5 inch mark and the corner 0.25 inch mark etched or marked with a closed square.

FIG. 1B illustrates a side view of the right angled piece 100 of FIG. 1A, in accordance with an embodiment of the present invention. The right angled piece 100 is between 0.05 and 0.15 inch in thickness.

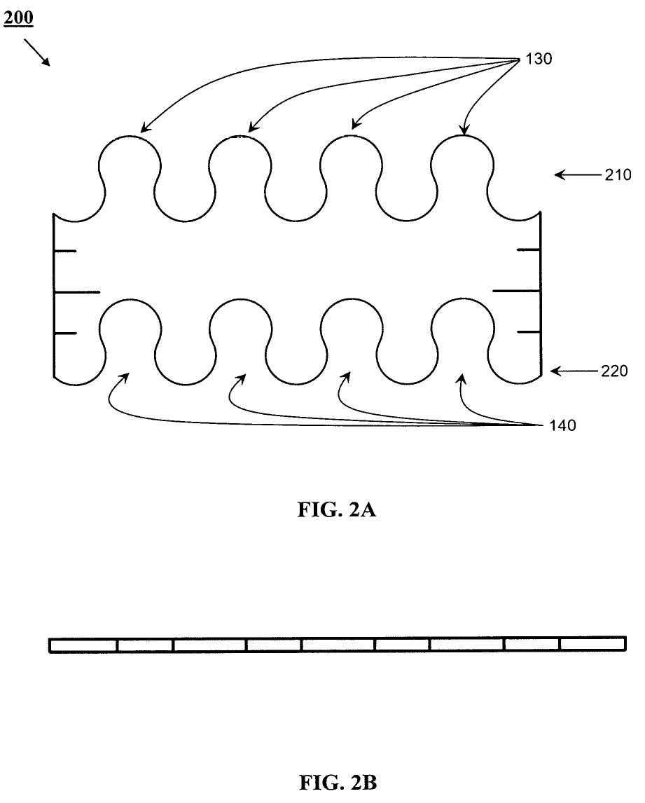

FIG. 2A illustrates a plan view of a first straight piece 200 in accordance with an embodiment of the present invention. The first straight piece 200 is made of a transparent material, 2.75 inches in width, and 1 inch in length, and having the five interlocking fingers 130 on one open end 210 and the corresponding five interlocking finger openings 140 on another open end 220.

FIG. 2B illustrates a side view of the first straight piece 200 of FIG. 2A, in accordance with an embodiment of the present invention. The first straight piece 200 is between 0.05 and 0.15 inch in thickness.

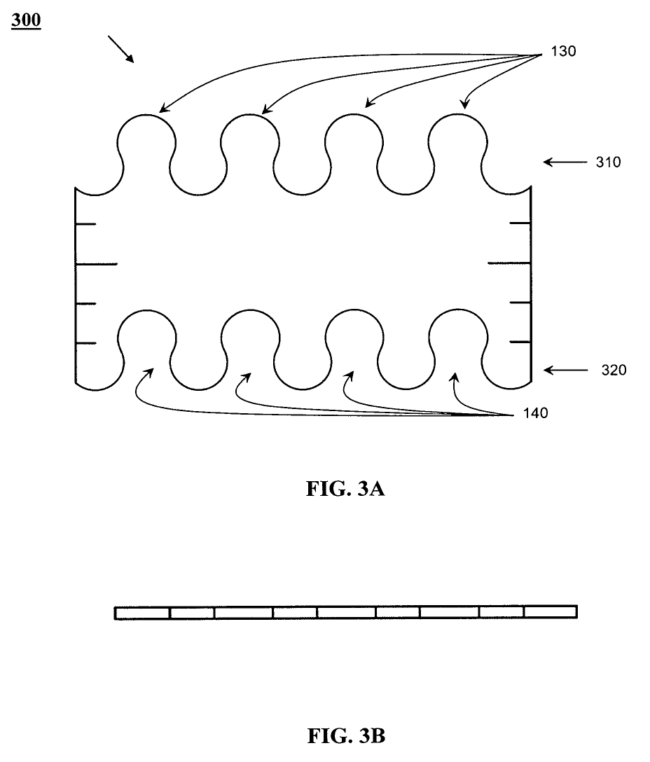

FIG. 3A illustrates a plan view of a second straight piece 300 in accordance with an embodiment of the present invention. The second straight piece 300 is made of a transparent material, 2.75 inches in width, and 1.5 inch in length, and having the five interlocking fingers 130 on one open end 310 and the corresponding five interlocking finger openings 140 on another open end 320.

FIG. 3B illustrates a side view of the second straight piece of FIG. 3A, in accordance with an embodiment of the present invention. The second straight piece 300 is between 0.05 and 0.15 inch in thickness.

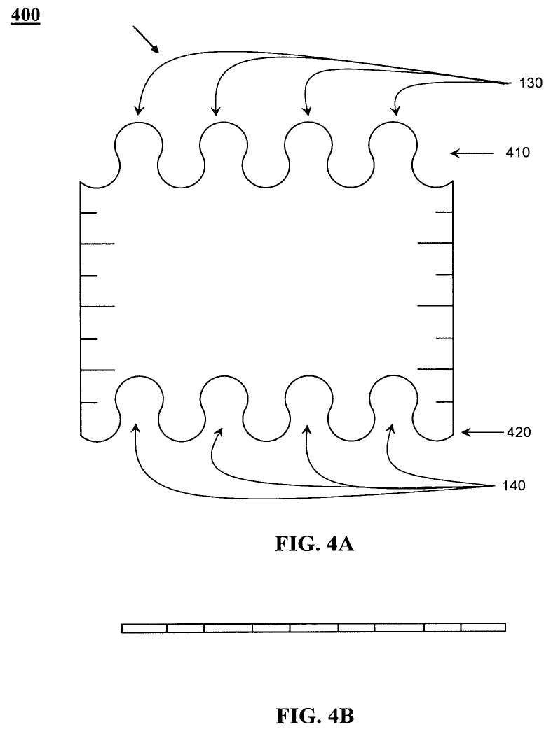

FIG. 4A illustrates a plan view of a third straight piece 400 in accordance with an embodiment of the present invention. The third straight piece 400 is made of a transparent material, 2.75 inches in width, and 2 inches in length, and having the five interlocking fingers 130 on one open end 410 and the corresponding five interlocking finger openings 140 on another open end 420.

FIG. 4B illustrates a side view of the third straight piece 400 of FIG. 4A, in accordance with an embodiment of the present invention. The third straight piece 400 is between 0.05 and 0.15 inch in thickness.

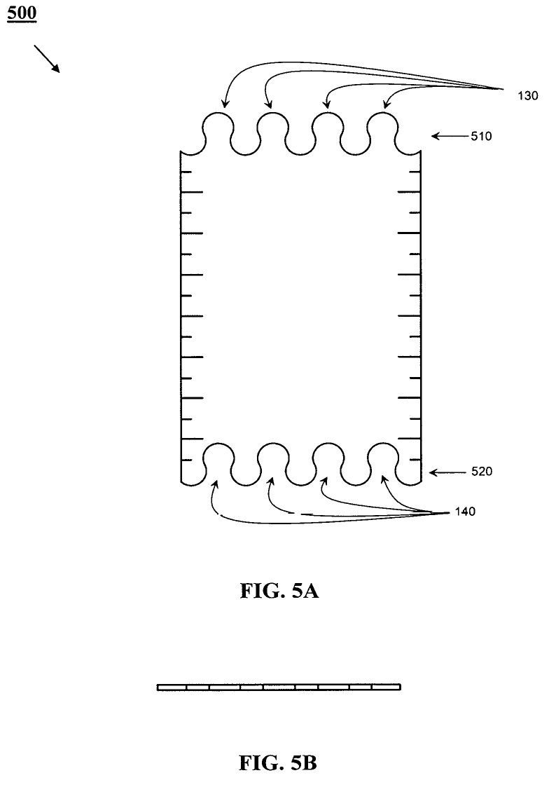

FIG. 5A illustrates a plan view of a fourth straight piece 500 in accordance with an embodiment of the present invention. The fourth straight piece 500 is made of a transparent material, 2.75 inches in width, and 4 inches in length, and having the five interlocking fingers 130 on one open end 510 and the corresponding five interlocking finger openings 140 on another open end 520.

FIG. 5B illustrates a side view of the fourth straight piece 500 of FIG. 5A, in accordance with an embodiment of the present invention. The fourth straight piece 500 is between 0.05 and 0.15 inch in thickness.

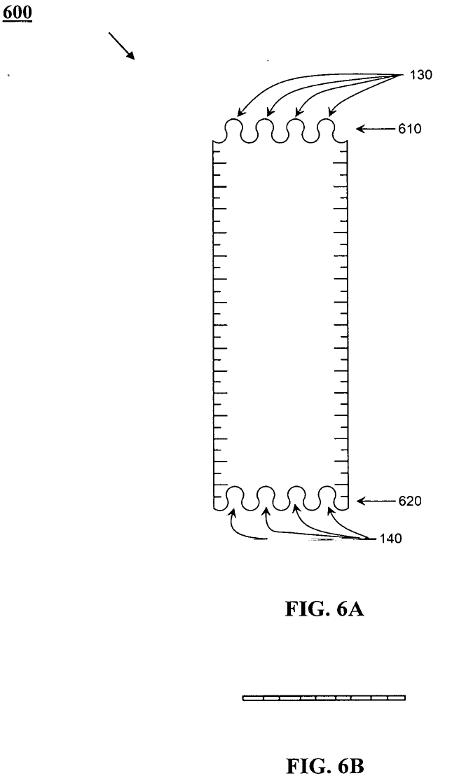

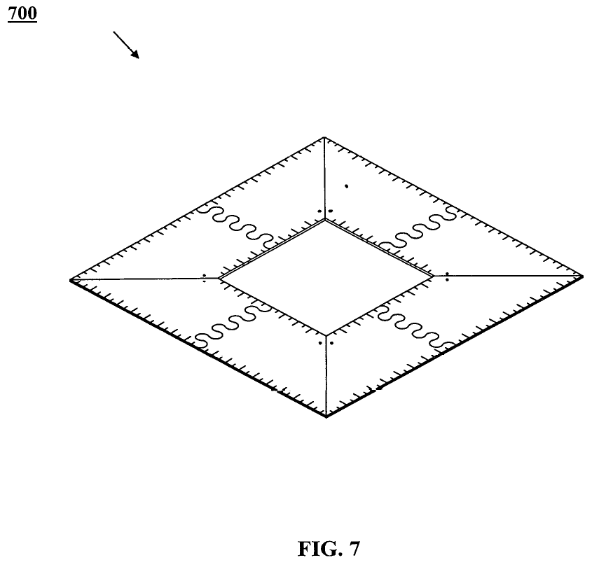

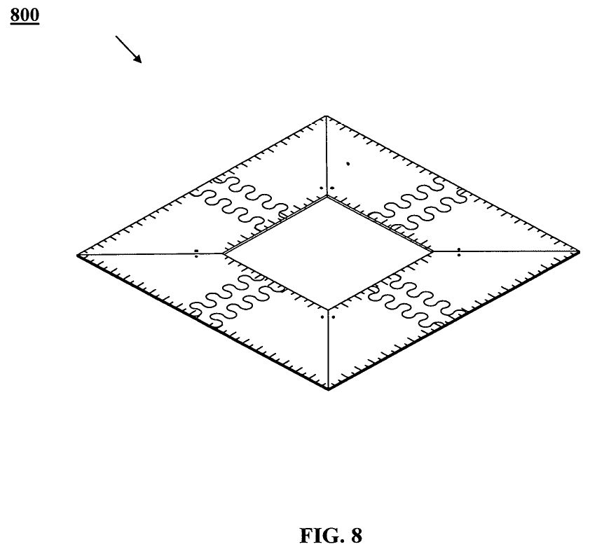

FIG. 6A illustrates a plan view of a fifth straight piece 600 in accordance with an embodiment of the present invention. The fifth straight piece 600 made of a transparent material, 2.75 inches in width, and 8 inches in length, and having the five interlocking fingers 130 on one open end 610 and the corresponding five interlocking finger openings 140 on another open end 620.

FIG. 6B illustrates a side view of the fifth straight piece 600 of FIG. 6A, in accordance with an embodiment of the present invention. The fifth straight piece 600 is between 0.05 and 0.15 inch in thickness.

The adjustable square ruler or measuring device can be adjusted by connecting four pieces with five interlocking fingers 130 which can be joined to four other straight pieces, each also with the five interlocking fingers 130, desired sizes ranging from 4 or 5 inches on the interior and 9.5 and 10.5 inches on the exterior, respectively and increasing at 0.5 inch increments to create a square or rectangle depending on the pieces utilized and the size desired.

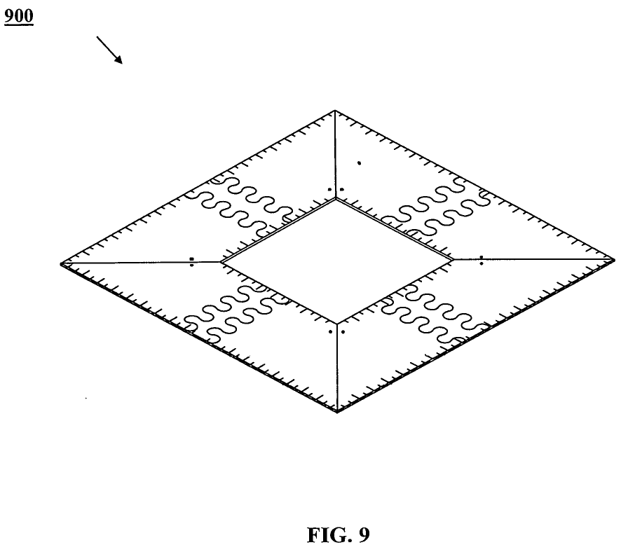

FIG. 7 illustrates an isometric view of an adjustable square ruler in accordance with an embodiment 700 of the present invention.

FIG. 8 illustrates an isometric view of an adjustable square ruler, having four identical straight pieces, in accordance with an embodiment 800 of the present invention.

FIG. 9 illustrates an isometric view of an adjustable square ruler, having four identical straight pieces, in accordance with another embodiment 900 of the present invention.

As seen in FIGS. 7, 8 and 9, the devise can be joined using the various pieces to create the smallest square having a 4 inch interior and a 9.5 inch exterior (FIG. 7) while FIG. 9 shows how using the 1½ inch piece changes the interior dimension to the ¼ number beginning at 5½ inches and exterior dimension on the whole number beginning at 11 inches.

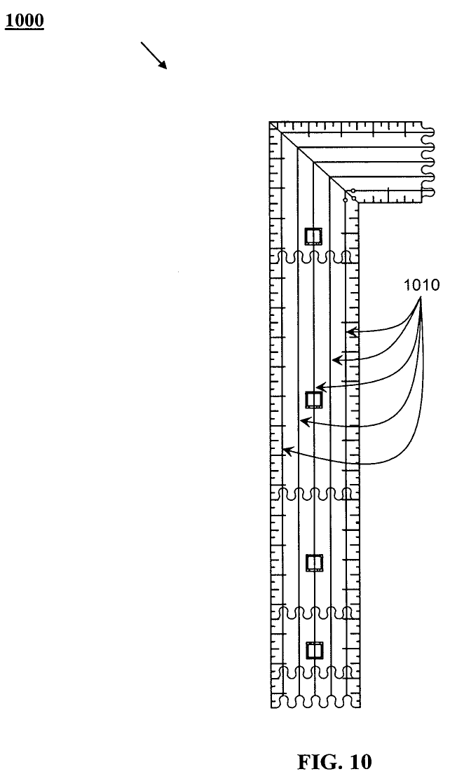

FIG. 10 illustrates the right angled piece 100, the fifth straight piece 600, the fourth straight piece 500, the third straight piece and the second straight piece 400 coupled together, in accordance with an embodiment 1000 of the present invention. As shown in FIG. 10, each one of the right angled piece 100, the first 200, the second 300, the third 400, the fourth 500 and the fifth straight piece 600 has etched or marked a plurality of parallel lines 1010, a first parallel line 0.375 inch from the inside and outside edge, together with three other such parallel lines 0.5 inch apart.

In accordance with an embodiment, the transparent material is PETG (Polyethylene terephthalate glycol-modified), a clear amorphous thermoplastic, or any similar thermoplastic, and has interlocking coupling fingers 130 or interlocking finger openings 140. Further, each one of the first, the second, the third, the fourth and the fifth straight piece has etched or marked along its outside and inside edge every 0.25 inch with the inch marking being largest, the 0.5 inch marking being half the size of the inch marking, the 0.25 inch marking being one half the 0.5 inch mark.

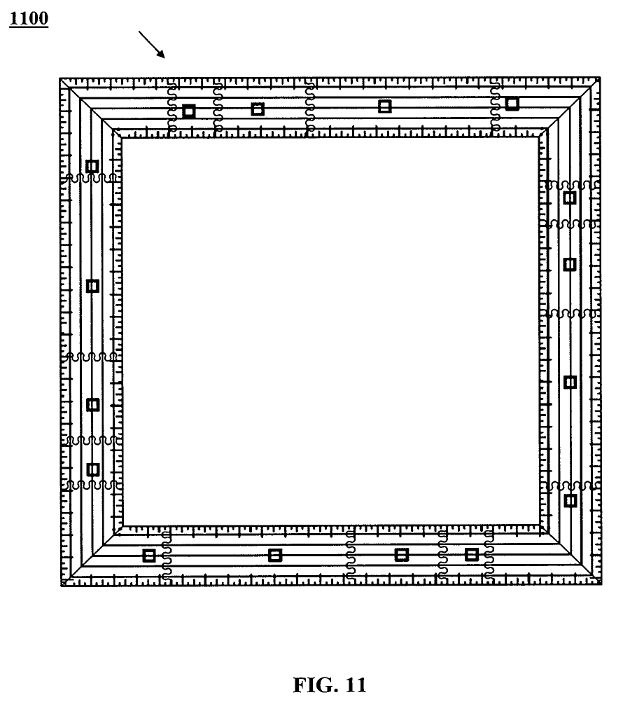

FIG. 11 illustrates a plan view of an adjustable square ruler in accordance with an embodiment 1100 of the present invention. If the right angled pieces 100 and the first 200, the third 400, the fourth 500 and the fifth straight pieces 600 are coupled together in various combinations the user can create squares having the following dimensions: 5 inch interior 10.5 inch exterior, 6 inch interior 11.5 inch exterior, 7 inch interior 12.5 inch exterior, 8 inch interior 13.5 inch exterior, 9 inch interior 14.5 inch exterior, 10 inch interior 15.5 inch exterior, 11 inch interior 16.5 inch exterior, 12 inch interior 17.5 inch exterior, 13 inch interior 18.5 inch exterior, 14 inch interior 19.5 inch exterior, 15 inch interior 20.5 inch exterior, 16 inch interior 21.5 inch exterior, 17 inch interior 22.5 inch exterior, 18 inch interior 23.5 inch exterior, and 19 inch interior 24.5 inch exterior.

If the right angled pieces 100 and the first 200, the second 300, the third 400, the fourth 500 and the fifth straight pieces 600 are coupled together in various combinations the user can then change the exterior dimension to the round number and the interior dimension to the half number and thus create squares having the following dimensions: 5.5 inch interior 11 inch exterior, 6.5 inch interior 12 inch exterior, 7.5 inch interior 13 inch exterior, 8.5 inch interior 14 inch exterior, 9.5 inch interior 15 inch exterior, 10.5 inch interior 16 inch exterior, 11.5 inch interior 17 inch exterior, 12.5 inch interior 18 inch exterior, 13.5 inch interior 19 inch exterior, 14.5 inch interior 20 inch exterior, 15.5 inch interior 21 inch exterior, 16.5 inch interior 22 inch exterior, 17.5 inch interior 23 inch exterior, 18.5 inch interior 24 inch exterior, 19.5 inch interior 25 inch exterior, and 20.5 inch interior 26 inch exterior.

If desired the user can configure the pieces to form closed rectangles to the desired size. The user may also purchase additional pieces or sets and create larger squares or rectangles.

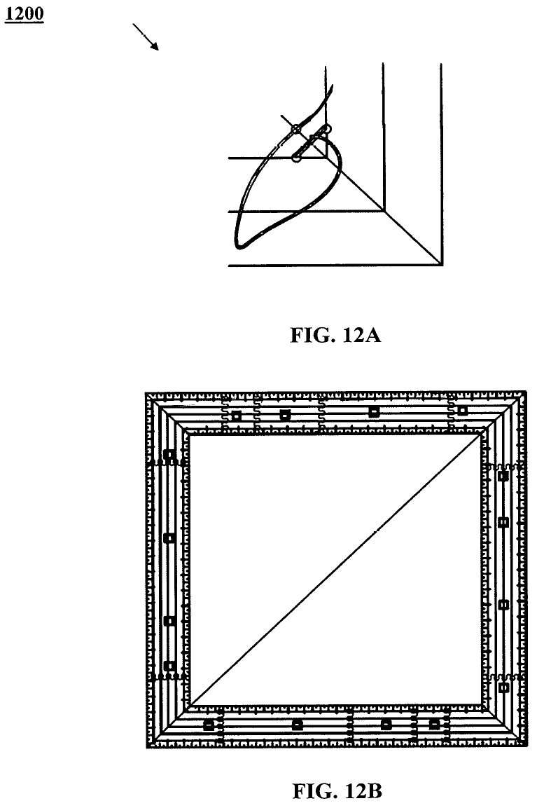

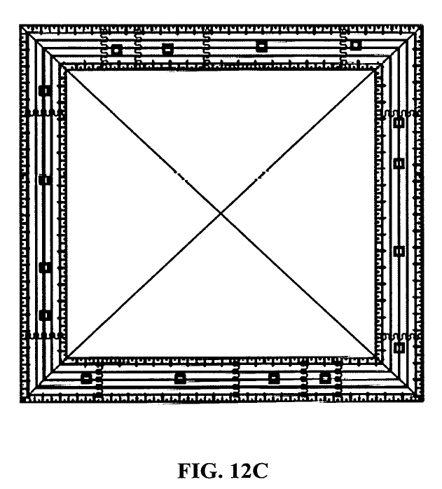

FIGS. 12A, 12B and 12C illustrate a plurality of visual steps for determining an exact center of the adjustable square ruler or measuring device using a heavy thread, in accordance with an embodiment 1200 of the present invention. FIG. 12A shows how to thread through the holes and FIGS. 12B and 12C show how to create diagonals using the thread. The use of heavy thread and placement of the square over the users finished project protects the underlying project. The exact center of the adjustable square ruler or measuring device can be determined using the thread and tying then weaving the thread through the corner holes creating an exact “X”, thus the geometric center of the square or triangle.

As shown in FIGS. 11, 12A, 12B and 12C, the pieces snap firmly into place by lining the pieces and pressing together and also ensuring the printed words are in the same direction. The pieces are easily separated by holding the pieces at or near the coupling and rotating one piece clockwise and the other piece counter-clockwise.

The plurality of parallel lines 1010 on the squares pieces together with the diagonals help the user to have proper placement prior to marking or cutting. The tool assures the user that the size will be uniform when multiple pieces need marked or cut. The thickness of the material and the interlocking coupling fingers assure the user the edges will be smooth and stable facilitating the easy use of rotary cutters.

The pieces are easily separated, easily stored and easily transported. (A 10 inch square and two inch deep, drawer storage box is provided by the inventors with the tool.)

1. An adjustable square ruler or measuring device, comprising:
four right angled pieces, each between 0.05 and 0.15 inch in thickness, made of a transparent material, each side 2.75 inches in width, with an interior length of 2 inches and an exterior length of 4.75 inches, and having five interlocking fingers on one open end and corresponding five interlocking finger openings on another open end;
four first straight pieces, each between 0.05 and 0.15 inch in thickness, made of a transparent material, 2.75 inches in width, and 1 inch in length, and having the five interlocking fingers on one open end and the corresponding five interlocking finger openings on another open end;
four second straight pieces, each between 0.05 and 0.15 inch in thickness, of a transparent material, 2.75 inches in width, and 1.5 inch in length, and having the five interlocking fingers on one open end and the corresponding five interlocking finger openings on another open end;
four third straight pieces, each between 0.05 and 0.15 inch in thickness, made of a transparent material, 2.75 inches in width, and 2 inches in length, and having the five interlocking fingers on one open end and the corresponding five interlocking finger openings on another open end;
four fourth straight pieces, each between 0.05 and 0.15 inch in thickness, made of a material, 2.75 inches in width, and 4 inches in length, and having the five interlocking fingers on one open end and the corresponding five interlocking finger openings on another open end;
four fifth straight pieces, each between 0.05 and 0.15 inch in thickness, made of a transparent material, 2.75 inches in width, and 8 inches in length, and having the five interlocking fingers on one open end and the corresponding five interlocking finger openings on another open end;
which four right angled pieces are coupled together either separately or together with four of any of the first, the second, the third, the fourth and the fifth straight pieces create a transportable, perfectly flat square or rectangular ruler which can be used for marking, trimming or cutting.

2. The adjustable square ruler or measuring device as claimed in claim 1 wherein each right angled piece has a diagonal line etched or marked from an outside corner to an inside corner.

3. The adjustable square ruler or measuring device as claimed in claim 2, wherein one hole with diameter between 0.02 and 0.04 inch is drilled on the diagonal line whose middle point is between 0.15 and 0.2 inch from the inside corner of the right angled piece.

4. The adjustable square ruler or measuring device as claimed in claim 3, wherein two holes with diameters between 0.02 and 0.04 inch are drilled at right angle points, with respective center points 0.25 inch from a center point of the drilled hole.

5. The adjustable square ruler or measuring device as claimed in any of the claims 1 through 4 wherein each right angled piece has etched or marked along its outside and inside edge every 0.25 inch with the inch marking being largest, the 0.5 inch marking being half the size of the inch marking, the 0.25 inch marking being one half the 0.5 inch mark and the corner 0.25 inch mark etched or marked with a closed square.

6. The adjustable square ruler or measuring device as claimed in claim 1 or claim 5, wherein each right angled piece has etched or marked a first plurality of parallel lines 0.375 inch from the inside and outside edges meeting at the diagonal line lines, together with three other such lines 0.5 inch apart meeting at the diagonal line.

7. The adjustable square ruler or measuring device as claimed in claim 1, wherein each one of the first, the second, the third, the fourth and the fifth straight piece has etched or marked along its outside and inside edge every 0.25 inch with the inch marking being largest, the 0.5 inch marking being half the size of the inch marking, the 0.25 inch marking being one half the 0.5 inch mark.

8. The adjustable square ruler or measuring device as claimed in claim 1 or claim 7, wherein each one of the first, the second, the third, the fourth and the fifth straight piece has etched or marked a plurality of parallel lines, a first parallel line 0.375 inch from the inside and outside edge, together with three other such parallel lines 0.5 inch apart.

9. The adjustable square ruler or measuring device as claimed in any of the claims 1 to 8 wherein the adjustable square ruler or measuring device is constructed of plastic.

10. The adjustable square ruler or measuring device as claimed in any of the claims 1 to 9 adjustable square ruler or measuring device can be adjusted by connecting four pieces with five interlocking fingers which can be joined to four other straight pieces, each also with the five interlocking fingers, desired sizes ranging from 4 or 5 inches on the interior and 9.5 and 10.5 inches on the exterior, respectively and increasing at 0.5 inch increments to create a square or rectangle depending on the pieces utilized and the size desired.

11. An adjustable square ruler or measuring device as claimed in any of the claims 1 to 4 an exact center of the adjustable square ruler or measuring device can be determined using a heavy thread and tying then weaving the thread through the corner holes creating an exact “X”, thus the geometric center of the square or rectangle.
